(19) United States
(12) Patent Application Publication
(10) Pub. No.: US 2012/0231275 A1
(43) Pub. Date: Sep. 13, 2012

(54) MIXTURE, LUMINESCENT COMPOSITION, PRODUCTION PROCESS AND USE

(75) Inventor: Tapio Harmia, Kaiserslautern (DE)

(73) Assignee: G.I.P.C. Holdings Ltd., Tel Aviv (IL)

(21) Appl. No.: 13/394,727

(22) PCT Filed: Sep. 6, 2010
(86) PCT No.: PCT/EP2010/063048

§ 371 Date: May 23, 2012

(30) Foreign Application Priority Data
Sep. 11, 2009 (DE) 10 2009 029 395.7

(51) Int. Cl. C09K 11/78; C09K 11/84; C09K 11/86; B32B 15/02; C09K 11/67; C09K 11/55; C09K 11/85; C09K 11/08; C09K 11/54

(52) U.S. Cl. 428/402; 252/301.4 R; 252/301.4 S; 252/301.4 H; 252/301.6 R; 252/301.6 S; 252/301.4 F

(57) ABSTRACT

The present invention concerns mixtures containing at least one luminescent composition, luminescent compositions, processes for the production of luminescent compositions and uses of the mixtures and compositions. To provide mixtures which can be used in small amounts for marking articles, substances and materials, wherein analysis and copying thereof is made more difficult, it is proposed according to the invention that the mixtures include at least one luminescent composition and at least one substantially non-luminescent composition, wherein the luminescent composition includes a mixed crystal of inorganic salts and the at least one substantially non-luminescent substance is an inorganic salt or a mixed crystal of inorganic salts.

The present invention concerns mixtures containing at least one luminescent composition, luminescent compositions, processes for the production of luminescent compositions and uses of the mixtures and compositions.

It is known that substances containing lanthanoid ions in the oxidation state +3, in particular lanthanoid oxide sulfides, luminesce, wherein excitation with radiation in the infra-red range causes the emission of short-wave light, for example in the visible range and/or in the UV range. Those substances or compositions containing such substances have characteristic emission spectra which can be detected with a read-out system adapted to the emission spectrum. For that reason for example lanthanoid oxide sulfides and compositions containing same are used as counterfeit protection for marking articles, substances or mixes of substances.

It has been found however that, depending on the respective use of the counterfeit protection, it is necessary to use large amounts of marking substance or marking composition. In addition in that respect there is the problem that the marking substance or composition can be chemically analysed by counterfeiters and possibly copied.

Therefore the object of the present invention is to provide mixtures or compositions which can be used in small amounts for marking articles, substances and materials, wherein the analysis and copying thereof is made more difficult.

That object is attained in that mixtures are used which, besides at least one luminescent composition, contain at least one substantially non-luminescent substance, wherein the luminescent composition includes a mixed crystal of inorganic salts and the at least one substantially non-luminescent substance is an inorganic salt or a mixed crystal of inorganic salts.

The term mixture is used here to denote a mechanical blend comprising at least two substances which are each present in the form of a solid substance.

The term mixed crystal is used in the present case to denote a crystal in which different salts are jointly contained in a crystal, wherein the salts can include two or more different cations and two or more different anions. Preferably the mixed crystal which is embraced by the at least one luminescent composition comprises different cations but only one single anion.

The term substantially non-luminescent substance is used is this respect to denote a substance which has no luminescence or whose luminescence is so slight that its luminescence does not measurably exceed the luminescence spectrum of the luminescent substance.

Particularly preferably the luminescence is an upconversion luminescence which is triggered by light or photon irradiation in the IR range.

It has been found in this respect that the addition of at least one substantially non-luminescent inorganic salt or mixed crystal does not influence the luminescence of the optically active mixed crystal or crystals. With such mixtures based on elementary analysis it is not possible to detect which constituents are responsible for the luminescence and thus for the characteristic spectrum.

The inorganic salt or the mixed crystal of the at least one substantially non-luminescent substance can be made up from identical, partly identical or different elements, in comparison with the inorganic salts which are contained in the mixed crystal of the luminescent composition. The characteristic luminescence spectrum of a luminescent mixed crystal is also influenced by the amount of the individual salts contained therein. It is therefore possible that the addition of one or more non-luminescent salts, of which the mixed crystal of the luminescent composition is made up, makes analysis and copying of the mixture difficult or impossible.

Examples of luminescent and substantially non-luminescent substances or such mixed crystals are known in large numbers in the state of the art.

Preferably the maximum luminescence intensity which the substantially non-luminescent substance has at a given excitation wavelength or excitation wavelength range and power, in comparison with the luminescent composition under the same conditions and in the same amount (for example mass) is less than 1/100 of the maximum luminescence intensity of the luminescent composition at a given luminescence wavelength or in a given range of luminescence wavelengths. The range of luminescence wavelengths corresponds in that respect to the range in which a read-out system analysis the emission, that is to say luminescence.

In certain embodiments the excitation wavelength can be in the range of between 850 and 1500 nm, preferably between about 920 and 1000 nm, particularly preferably between about 950 and 1000 nm, most preferably between 975 and 985 nm, and the luminescence wavelengths can be in the range of between 300 nm and 1700 nm. Preferably irradiation is effected for detecting the presence of a luminescent composition or a substantially non-luminescent substance respectively at excitation power levels of between 1 and 200 mW, in particular between 10 and 80 mW.

Particularly preferably the ratio of the at least one non-luminescent substance to the at least one luminescent composition is between 1/100 and 100/1, preferably between 1/50 and 1/1.

Preferably the at least one luminescent composition includes a mixed crystal of at least two salts, particularly preferably at least three salts, selected from the group consisting of oxides, oxide sulfides, oxide fluorides and oxide sulfide fluorides of yttrium, lanthanum, cerium, praseodymium, neodymium, samarium, europium, gadolinium, terbium, dysprosium, holmium, erbium, thulium, ytterbium and lutetium, wherein at least one salt contains lanthanum and/or yttrium.

Examples of luminescent compositions are disclosed inter alia in U.S. Pat. No. 6,802,992, namely red-luminescent mixed crystals, which include for example yttrium-erbium-ytterbium-oxide sulfide, gadolinium-erbium-ytterbium-oxide sulfide and some other mixed crystals.

EP 2 038 371 also discloses examples of luminescent mixed crystals and the production thereof.

Substantially non-luminescent substances comprising partly identical elements like the luminescent mixed crystals are for example ytterbium oxide or gadolinium oxide. Further examples of non-luminescent mixed crystals are inter alia a lanthanum oxide fluoride which contains 1% Yb, 1.5% Er and 0.5% Dy, an yttrium oxide fluoride which contains 2% Yb, 1% Er, 0.5% Pr, 0.5% Tb, or an yttrium oxide which contains 10% Yb, 2% Er, 0.5% SM and 0.1% Fe.

Lanthanoid mixed crystals generally involve a measurable luminescence which however can be different inter alia depending on the respective stoichiometry and production conditions and cannot be predicted or can be predicted only with difficulty. On the basis of measurement methods known to the man skilled in the art he can easily distinguish luminescent compositions from substantially non-luminescent substances.

The mixed crystal of the at least one luminescent composition can comprise a single crystalline phase, in other embodiments however the mixed crystal of the at least one luminescent composition can also have crystals of a plurality of phases, for example two phases. Gradients in respect of the stoichiometric composition can also occur within the mixed crystal of the at least one luminescent composition.

This involves luminescent mixed crystals with ‘upconverter’ or ‘anti-Stokes’ properties. The luminescence can be attributed to the fact that electrons of the 4 f shell of lanthanoid ions are raised upon irradiation by sequential multiple excitation to an energy state which is of an increased level in comparison with the absorption of a single photon. Upon relaxation a more energy-rich photon than the originally absorbed photon can be emitted from that energy state.

The mixed crystal of the at least one luminescent composition can be present in relatively coarse crystalline particles or in finely ground form.

Besides an yttrium and/or lanthanum salt the mixed crystal of the at least one luminescent composition in preferred embodiments may comprise one or two or more further salts.

In the mixed crystal of the at least one luminescent composition the salt or salts containing lanthanum and/or yttrium are present in relation to the mixed crystal preferably in a proportion of ≧50 molar %, ≧75 molar % and particularly preferably ≧85 molar %.

The further contained salt or salts can preferably be present in proportions of ≦30 molar %, preferably between 1 and 20 molar % and particularly preferably between 2 and 15 molar % with respect to the mixed crystal.

Preferably in that case the salt or salts not containing lanthanum and/or yttrium, are selected from ytterbium and at least one element selected from erbium, holmium and thulium. Mixed crystals made up from those salts of the at least one luminescent composition have particularly characteristic and intensive luminescences.

Further preferably the at least one luminescent composition comprises a mixed crystal of inorganic salts doped with at least one dopant. In that case the dopant causes a change in the characteristic emission spectrum of the luminescent composition. Therefore different spectra for the luminescent composition can be obtained by the addition of one or more different dopants in various amounts.

In a particularly preferred embodiment the dopant is selected from the group consisting of oxides and fluorides of main and sub-group elements. It will be appreciated that this involves only such elements which with oxygen and/or fluorine can form an oxide or fluoride. These are preferably elements of the 1st through 6th main group (IA though VIA) and the sub-group elements (groups IIIB, IVB, VB, VIB, VIIB, VIII, IB, IIB) including lanthanoids. Preferably, for reasons of handleability, no oxides and fluorides of elements or isotopes are used, which are subject to radioactive decay, for example elements with an atomic number of 84 and more.

Preferably the dopants are selected from oxides and fluorides of alkali metals, alkaline earth metals and sub-group elements. Preferred dopants are oxides and fluorides of calcium, zinc and titanium, for example in the form of the oxides calcium oxide, zinc oxide and titanium dioxide.

Those dopants are preferably present in a proportion respectively of ≦30 molar %, preferably ≦10 molar % and particularly preferably ≦5 molar % with respect to the composition of mixed crystal and dopant.

In a further preferred embodiment the at least one substantially non-luminescent substance is selected from oxides, sulfides, fluorides, oxide sulfides, oxide fluorides and oxide sulfide fluorides of a main or sub-group element and mixed crystals thereof. It will be appreciated that the main and sub-group elements are only such elements which are capable of forming an oxide or fluoride with oxygen and/or fluorine. Particularly preferred are elements of the 1st through 6th main group (IA though VIA) and the sub-group elements (groups IIIB, IVB, VB, VIB, VIIB, VIII, IB, IIB) including lanthanoids. Preferably, for reasons of handleability, no oxides and fluorides of elements or isotopes are used, which are subject to radioactive decay, for example elements with an atomic number of 84 and more.

Preferably the at least one substantially non-luminescent substance in the mixture is selected from the group consisting of oxides, sulfides, fluorides, oxide sulfides, oxide fluorides and oxide sulfide fluorides of yttrium, lanthanum, cerium, praseodymium, neodymium, samarium, europium, gadolinium, terbium, dysprosium, holmium, erbium, thulium, ytterbium, lutetium, alkali metals, alkaline earth metals and sub-group elements and mixed crystals thereof. In that way the substantially non-luminescent substance provides for the introduction into the mixture of elements which are generally suitable for being contained in luminescent mixed crystals with good luminescence properties.

Preferably the at least one substantially non-luminescent substance in the mixture is selected from the group consisting of oxides, sulfides, fluorides, oxide sulfides, oxide fluorides and oxide sulfide fluorides of cerium, praseodymium, neodymium, samarium, europium, gadolinium, terbium, dysprosium, holmium, erbium, thulium, ytterbium, lutetium, alkali metals, alkaline earth metals and sub-group elements and mixed crystals thereof.

In a preferred embodiment the at least one substantially non-luminescent substance is selected from oxides, sulfides, fluorides, oxide sulfides, oxide fluorides and oxide sulfide fluorides of yttrium, lanthanum, holmium, erbium, thulium, ytterbium, calcium zinc and titanium.

In a preferred embodiment of the invention the mixture contains at least two, preferably precisely three, luminescent compositions. Such mixtures have a sufficiently complex luminescence scheme to make analysis of the mixed crystals contained therein difficult or approximately impossible. In addition in particular a mixture containing three luminescent compositions affords great options in terms of variations in respect of the luminescence spectrum so that it is possible to produce almost any number of different analysable luminescence spectra. At the same time the distinguishability of different spectra is particularly good in the case of mixtures with precisely three luminescent compositions.

The above-indicated object is also attained by a process for the production of a luminescent composition which includes the following steps:

i) mixing and homogenising a mix in powder form which includes the following constituents:
(a) at least three components selected from the group consisting of oxides, sulfides, fluorides, oxide sulfides, oxide fluorides and oxide sulfide fluorides of yttrium, lanthanum, cerium, praseodymium, neodymium, samarium, europium, gadolinium, terbium, dysprosium, holmium, erbium, thulium, ytterbium and lutetium, or corresponding compounds which are converted by heating into oxides, sulfides or fluorides, wherein at least one component contains lanthanum and/or yttrium, and
(b) at least one dopant selected from oxides and/or fluorides or main or sub-group elements,

ii) adding a blend of fluoride and an alkali metal carbonate to the mix of step i) and mixing and/or homogenising with the mix of step i) to produce a mix,

iii) heating the homogenised mix of step ii) for between 2 h and 30 h to a temperature of more than 600° C., and

iv) cooling the heated mix of step iii) to give a solid mass of a luminescent composition.

The term mix in step i) and step ii) is used to denote a combination of solid substances which are mixed together. This involves the initial substances and auxiliary substances used for the production of a luminescent composition.

Luminescent compositions which contain a mixed crystal with a doping can be produced by the addition of the fluoride in step ii). Those compositions have increased luminescence intensity in comparison with luminescent compositions produced with conventional processes. In addition the thermal stability of that composition is increased in comparison with luminescent compositions produced with conventional processes.

In regard to the dopant it will be appreciated that this only involves oxides and/or fluorides of those elements which are capable of forming an oxide or fluoride with oxygen and/or fluorine. Elements in the 1st through 6th main groups (group IA through VIA) and the sub-group elements (groups IIIB, IVB, VB, VIB, VIIB, VIII, IB, IIB) including lanthanoids are preferred. Alkali metals and alkaline earth metals as well as sub-group elements, in particular calcium, zinc and titanium are particularly preferred.

In a preferred embodiment of the invention the process according to the invention further includes the following steps:

v) comminuting the solid mass obtained in step iv), giving a powder,

vi) washing the powder of step v) in water, and

vii) centrifuging off and/or filtering the powder, giving a precipitate or residue, and

viii) optionally further comminuting the precipitate or residue from step vii) until obtaining the desired mean or maximum particle size.

That gives particularly pure compositions which have a defined particle size distribution. That is important in particular when using such compositions in connection with further luminescent compositions as the particle size distribution and the mean and maximum particle size have an influence on the luminescence spectrum of the composition produced in that way.

Preferably in a further step in the process at least one substantially non-luminescent substance and optionally one or more further luminescent compositions are added to the luminescent composition and mixed, giving a mixture.

In a particularly preferred embodiment of the invention the fluoride in step ii) is present in an amount of between 10% by mass and 60% by mass, preferably between 25% by mass and 30% by mass with respect to the total mixture in step ii).

It has surprisingly been found in that respect that, in spite of the large amount of fluoride used, it is not incorporated into the mixed crystal and the stoichiometry of the resulting mixed crystal is not altered thereby. That large amount of fluoride however leads to an increase in luminescence intensity by up to between 5 and 7 times in comparison with smaller amounts used.

Preferably the blend of fluoride and alkali metal carbonate in step ii) is added together with elementary sulfur.

In preferred embodiments of the invention the proportion of fluoride in the added blend in step ii) is between 5% by mass and 70% by mass, preferably between 25% by mass and 70% by mass, particularly preferably between 33% by mass and 40% by mass, with respect to the blend of alkali metal carbonate, elementary sulfur and fluoride.

The stoichiometries of the luminescent compositions produced can be influenced by a variation in the ratios of alkali metal carbonate and fluoride and optionally elementary sulfur relative to each other as well as the oxygen partial pressure in the heating operation in step iii).

Preferably an alkali metal or alkaline earth metal fluoride is added as the fluoride in step ii).

The fluoride is preferably potassium fluoride. The alkali metal carbonate is preferably sodium carbonate.

In addition a luminescent composition obtained by the process according to the invention is in accordance with the invention. That composition has similar or identical stoichiometries to luminescent compositions obtained with conventional processes. However the luminescence intensity is surprisingly increased by between 5 and 7 times in comparison with luminescent compositions produced with conventional processes. Furthermore luminescent compositions produced in that way have increased thermal stability. It is assumed that the fluoride added in the process according to the invention possibly affords homogeneous distribution of the atomic components and thus a homogeneous crystal, in comparison with conventional production processes.

The resulting luminescent compositions can be used in smaller amounts for marking articles, substances and mixes of substances, in comparison with conventional compositions, so that analysis of the marking composition is made more difficult due to the small amount involved.

Differing stoichiometries of the resulting mixed crystal can be produced with the process according to the invention inter alia by a variation in the temperature in step ii).

Further in accordance with the invention is a luminescent composition having the general formula (I):

G_{q}L_{1-q} (I),

wherein

q is a number between 0 and 1, preferably between 0.8 and 1, particularly preferably between 0.9 and 1, and

G is of the following formula (II):

Y₂₋ₓLaₓO_{3-y-z}SyF_{2z} (II)

wherein

x=between 0 and 2,

y=between 0 and 1, preferably y˜0 or ˜1,

z=between 0 and 0.25, preferably z=between 0.001 and 0.1, and

L is selected from two or more components of the following formula (III):

M′_{c}M″_{2-c}O_{3-a-b}SₐF_{2b} (III)

wherein

c=between 0 and 2,

a=between 0 and 1, preferably a˜0 or ˜1,

b=between 0 and 0.25, preferably b=between 001 and 0.1, and

M′ and M″ are respectively selected independently of each other from the group consisting of the trivalent cations of cerium, praseodymium, neodymium, samarium, europium, gadolinium, terbium, dysprosium, holmium, erbium, thulium, ytterbium and lutetium, wherein for each component in L the variables M′ and M″ stand for different trivalent cations,

wherein in the composition a=y and b=z.

For example besides yttrium and/or lanthanum the composition of formula (I) may also contain two, three, four, five, six, seven or still further elements M. As a maximum thirteen different trivalent cations M are included. By way of example a composition according to the invention contains lanthanum and yttrium oxide, holmium, erbium and thulium oxide.

In an embodiment of the invention the composition is an oxide fluoride, wherein y and a in formula (I) are both 0. In a further embodiment the invention is an oxide sulfide, wherein z and b in the foregoing formula (I) are both 0. In still a further embodiment the composition is an oxide sulfide fluoride, wherein in the composition according to foregoing formula (I) y and a and z and b are different from 0. In still a further embodiment the composition is an oxide, wherein in formula (I) y, a, z and b are 0.

It is also preferred in that respect that, when y or a are not 0, z or b are also not 0. Further preferably y is either 0 or 1 and a is either 0 or 1.

Particularly preferably the luminescent composition in accordance with foregoing general formula (I) is produced by a process according to the invention as described hereinbefore.

The luminescent composition is usually in particles. Preferably the mean particle size is in the range of between 1 nm and 300 μm, particularly preferably in the range of between 1 μm and 45 μm.

It has been found in that respect that this particle size is particularly suitable for a large number of applications, for example in printing processes or for marking weaving threads etc. In addition this involves a particle size which is well reproducible. It has been found that, with such luminescent compositions, the luminescence spectrum also depends on the particle size or the particle size distribution. For that reason good reproducibility is advantageous in the region of a mean particle size of between 1 μm and 45 μm.

The luminescent compositions according to the invention are a luminescence substance with ‘upconverter’ and/or ‘anti-Stokes’ properties. They preferably occur in crystalline form, that is to say as a mixed crystal. It is further preferred for the composition to comprise a single phase, for example a crystalline phase, which can be determined by X-ray diffractometric methods. In certain embodiments the composition may also comprise a plurality of phases, for example two phases. Gradients of the stoichiometric composition may also occur within the mixed crystal.

In a particularly preferred embodiment of the invention a mixture according to the invention which can be used for marking articles or substances or mixes of substances contains at least one luminescent composition according to the invention which is produced by the above-described process and/or which involves the above-described stoichiometry.

Preferably all luminescent compositions contained in a mixture according to the invention are compositions according to the invention which are particularly preferably produced by the process according to the invention.

Preferably the compositions according to the invention and mixtures according to the invention are used for marking articles, substances or mixes of substances, wherein the composition is applied to or introduced into the article, the substance or the mix of substances.

In a further preferred embodiment the mixture or the composition is applied to or introduced into the article, the substance or the mix of substances in the form of a blend or a pattern.

Articles, substances or mixes of substances which are marked with a mixture or a composition according to the invention are also in accordance with the invention.

The luminescence substances according to the invention can be used as identification and marking substances, for example as security markings on articles, substances or mixes of substances. In that way it is possible to determine the authenticity of articles, for example products or documents. As the luminescence substance is chemically inert it can be introduced into or applied to any solid and/or liquid substances or mixtures of substances. For example the luminescence substance can be applied to or introduced into carrier substances such as for example paint and lacquer, toner, inks, dyes etc or products like plastics, metals, glass, silicone, paper, rubber etc. The luminescence substance according to the invention is also suitable for use in biological systems, for example cell cultures, samples of body fluids or tissue sections or as contrast agents. In that respect the luminescence substance can be coupled in nano- or microparticulate form to biological detection reagents. In addition the surfaces of particles of the luminescence substance can be modified with deodetomines or other bonding substances to improve the suspending properties, for example in organic liquids such as for example oils, benzines, liquefied gases etc, in aqueous liquids such as for example body fluids, in aqueous-organic liquid systems and powders capable of flow such as for example toners. The smaller the particles are, the corresponding lesser is their tendency to sedimentation. For example the particle size can be reduced by intensive milling to such an extent, for example to <10 nm, that a stable suspension of the particles in liquids is achieved even without the addition of bonding substances.

Security against forgery of the marking is afforded by the emission lines characteristic of the respective luminescence substance representing a cryptographic key which can be detected with a detector, for example the lock, which is matched to the respective substance. Analysis of the luminescent compositions used is made difficult or approximately impossible by the use of the mixtures and compositions according to the invention so that copying of the forgery safeguard is prevented.

Detection of the presence of the luminescence substance can be implemented by irradiation with a wavelength in the infrared range, in particular with IR monocoherent laser light or with an IR light emitting diode with wavelengths in the range of between about 850 and 1500 nm, preferably between about 920 and 1000 nm, particularly preferably between about 950 and 1000 nm, most preferably between 975 and 985 nm, wherein the luminescent substance is excited and the emission radiation in the range of wavelengths characteristic of the respective luminescent substance, for example in the range of between 300 and 1700 nm, is detected. Irradiation is preferably effected with a power of 1-200 mW, in particular 10-80 mW. Irradiation of the product containing the luminescent substance can be effected directly or with an optical waveguide or another optically relevant transfer medium, for example an optical solid body, a fluid, gas etc. Detection can be effected visually or by means of detectors.

It is possible for example to use optical waveguides whose heads are ground as converging lenses so that incident light (IR light) and light emitted by the luminescence substance (specific emission spectrum) form one unit and can be focused at the same point. An advantage in that respect is that no mechanical misadjustment can occur between the receiver and the transmitter. The attenuation factor of the optical waveguide, for example of glass or plastic, can vary, wherein the transition from the optical components (radiation source or detection element respectively) to the optical waveguide is of a low-covision nature. The length of the optical waveguide can vary and is typically between 1 cm and 50 cm.

In a particularly preferred embodiment a luminescence substance with a characteristic emission spectrum is detected by a read-out system which is adapted to that emission spectrum. The read-out system includes a radiation source, preferably a radiation source in the IR range, and one or more optical detection elements provided for selective detection of specific emission lines of the luminescence substance, for example in respect of wavelength and/or intensity. The detection elements can be for example diodes, photoelements or electronic detectors. Detector matrices having a plurality of preferably differently set detectors are preferably used, for example diode, photoelement or CCD matrices. The detectors or individual detectors of the detector matrix can be combined with optical filters, for example band pass filters, which can also be vapor-deposited on the detection element. The filters are preferably so selected that they only allow light to pass in a given wavelength range, for example a range of 5-15 nm, preferably about 10 nm. The filters preferably contain high- and low-refraction layers such as TiO₂ and SiO₂. That ensures that band pass filters with very small rise-fall flanks per optical element are afforded. The passage of light which does not correspond to the wavelength characteristic of the luminescence substance is prevented.

Using detectors or detector matrices which detect a plurality of emission lines of differing wavelength, for example 2, 3, 4 or more emission lines, which are characteristic of a respective luminescence substance, can afford a verification system with a high level of security. The read-out system can possibly also include detectors which operate at wavelengths at which there is no emission line and thus serve as a negative control.

The read-out system can possibly also include a programmable electronic unit which can be reprogrammed as required to respective other emission lines.

In addition a plurality of different luminescence substances can be applied to an article, for example a product or a carrier, which can be evaluated either visually with different colors and/or by detectors. In that case those different applications can be arranged beneath, above or beside each other so as to afford a complex and characteristic pattern. Thus for example when applying two different luminescence substances to a product in mutually juxtaposed relationship, two different colors are emitted upon irradiation with a suitable IR source, giving a flip-flop effect.

The mixture and compositions according to the invention can also be combined with other verification systems, for example based on bacteriorhodopsin or specific DNA sequences.

The accompanying Figures show the luminescences of luminescent compositions produced with different processes. In the Figures:

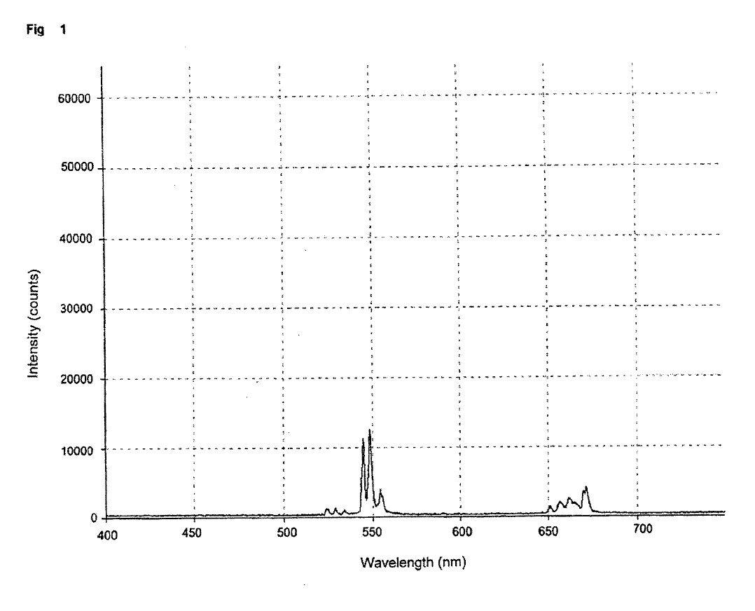

FIG. 1 shows the luminescence of a composition produced with a conventional process, and

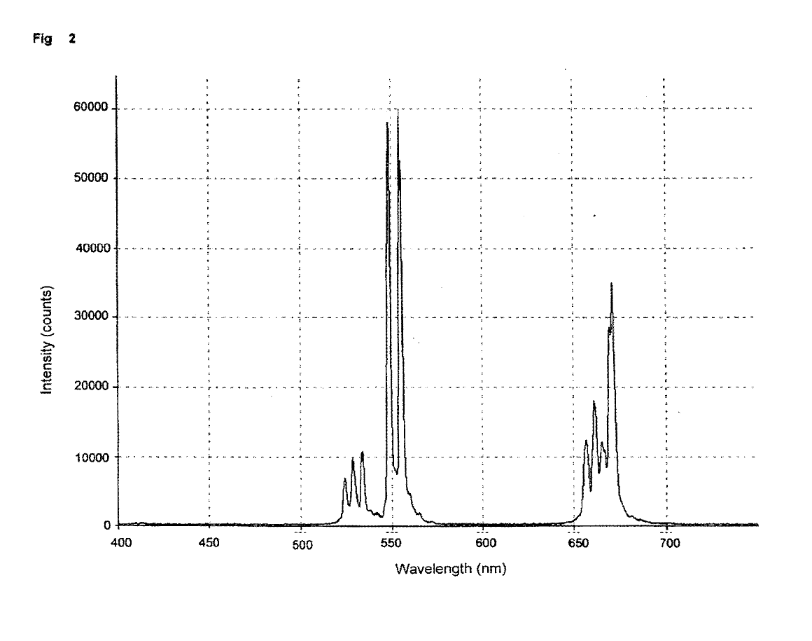

FIG. 2 shows the luminescence of a composition produced with a process according to the present invention.

In FIG. 1 the luminescence of the luminescent composition produced with a conventional process is a maximum of about 12,000 counts in a wavelength range of between 400 nm and 800 nm.

FIG. 2 shows the luminescence of a luminescent composition which very substantially corresponds in its stoichiometry and the manner of manufacture to the composition of FIG. 1, with the exception of the fact that, in production of the composition, prior to the sintering operation, potassium fluoride was added in combination with an alkali metal carbonate. It is shown that the maximum luminescence of the composition produced in that way is about 60,000 counts in the wavelength range of between 400 nm and 800 nm and is thus about five times in comparison with the composition produced using the conventional method.

In both cases measurement of luminescence was effected with the Ocean Optics SpectraSuite device with a respective integration time of 7 milliseconds and with the same excitation intensity and wavelength. Equal amounts of the compositions were used for each respective measurement.

1. A mixture comprising at least one luminescent composition and at least one substantially non-luminescent substance, wherein the luminescent composition includes a mixed crystal of inorganic salts and the at least one substantially non-luminescent substance is an inorganic salt or a mixed crystal of inorganic salts.

2. The mixture according to claim 1 in which the maximum luminescence intensity which the substantially non-luminescent substance has at a given excitation wavelength or excitation wavelength range and power, in comparison with the luminescent composition under the same conditions and in the same amount is less than 1/100 of the maximum luminescence intensity of the luminescent composition in a given range of luminescence wavelengths.

3. The mixture according to claim 1, wherein the at least one luminescent composition includes a mixed crystal of at least two salts selected from oxides, oxide sulfides, oxide fluorides and oxide sulfide fluorides of yttrium, lanthanum, cerium, praseodymium, neodymium, samarium, europium, gadolinium, terbium, dysprosium, holmium, erbium, thulium, ytterbium and lutetium, wherein at least one salt contains lanthanum and/or yttrium.

4. The mixture according to claim 3, wherein the salt or salts containing lanthanum and/or yttrium, with respect to the mixed crystal, are present in a proportion of ≧50 molar %.

5. The mixture according to claim 3, wherein the salt or salts not containing lanthanum and/or yttrium, with respect to the mixed crystal, are present in a proportion of ≦30 molar %.

6. The mixture according to claim 3, wherein the salt or salts not containing lanthanum and/or yttrium, are selected from ytterbium and at least one element selected from erbium, holmium and thulium.

7. The mixture according to claim 1, wherein the at least one luminescent composition comprises a mixed crystal of inorganic salts with at least one dopant.

8. The mixture according to claim 6, wherein the at least one dopant is selected from oxides and fluorides of main and sub-group elements.

9. The mixture according to claim 7, wherein the at least one dopant is selected from oxides and fluorides of alkali metals, alkaline earth metals and sub-group elements.

10. The mixture according to claim 7, wherein the dopant in relation to the composition of mixed crystal and dopant is present in a proportion of ≦30 molar %.

11. The mixture according to claim 1, wherein the at least one substantially non-luminescent substance is selected from oxides, sulfides, fluorides, oxide sulfides, oxide fluorides and oxide sulfide fluorides of a main or sub-group element and mixed crystals thereof.

12. The mixture according to claim 11, wherein the at least one substantially non-luminescent substance is selected from oxides, sulfides, fluorides, oxide sulfides, oxide fluorides and oxide sulfide fluorides of yttrium, lanthanum, cerium, praseodymium, neodymium, samarium, europium, gadolinium, terbium, dysprosium, holmium, erbium, thulium, ytterbium, lutetium, alkali metals, alkaline earth metals and sub-group elements and mixed crystals thereof.

13. The mixture according to claim 12, wherein the at least one substantially non-luminescent substance is selected from oxides, sulfides, fluorides, oxide sulfides, oxide fluorides and oxide sulfide fluorides of yttrium, lanthanum, holmium, erbium, thulium, ytterbium, calcium, zinc and titanium.

14. The mixture according to claim 1, wherein at least two luminescent compositions are contained.

15-22. (canceled)

23. A luminescent composition wherein the composition is of the general formula (I):
G_{q}L_{1-q} (I),
wherein
q is a number between 0 and 1, preferably between 0.8 and 1, particularly preferably between 0.9 and 1, and
G is of the following formula (II):
Y₂₋ₓLaₓO_{3-y-z}SyF_{2z} (II)
wherein
x=between 0 and 2,
y=between 0 and 1, preferably y˜0 or ˜1,
z=between 0 and 0.25, preferably z=between 0.001 and 0.1, and
L is selected from two or more components of the following formula (III):
M′_{c}M″_{2-c}O_{3-a-b}SₐF_{2b} (III)
wherein
c=between 0 and 2,
a=between 0 and 1, preferably a˜0 or ˜1,
b=between 0 and 0.25, preferably b=between 001 and 0.1, and
M′ and M″ are respectively selected independently of each other from the group consisting of the trivalent cations of cerium, praseodymium, neodymium, samarium, europium, gadolinium, terbium, dysprosium, holmium, erbium, thulium, ytterbium and lutetium, wherein for each component in L the variables M′ and M″ stand for different trivalent cations,
wherein in the composition in accordance with formula (I), a=y and b=z.

24. (canceled)

25. The luminescent composition according to claim 23, wherein the mean particle size of the particles is in the range of between 1 nm and 300 μm.

26. The mixture according to claim 1, wherein the at least one luminescent composition is of the general formula (I):
G_{q}L_{1-q} (I),
wherein
q is a number between 0 and 1, preferably between 0.8 and 1, particularly preferably between 0.9 and 1, and
G is of the following formula (II):
Y₂₋ₓLaₓO_{3-y-z}SyF_{2z} (II)
wherein
x=between 0 and 2,
y=between 0 and 1, preferably y˜0 or ˜1,
z=between 0 and 0.25, preferably z=between 0.001 and 0.1, and
L is selected from two or more components of the following formula (III):
M′_{c}M″_{2-c}O_{3-a-b}SₐF_{2b} (III)
wherein
c=between 0 and 2,
a=between 0 and 1, preferably a˜0 or ˜1,
b=between 0 and 0.25, preferably b=between 001 and 0.1, and
M′ and M″ are respectively selected independently of each other from the group consisting of the trivalent cations of cerium, praseodymium, neodymium, samarium, europium, gadolinium, terbium, dysprosium, holmium, erbium, thulium, ytterbium and lutetium, wherein for each component in L the variables M′ and M″ stand for different trivalent cations,
wherein in the composition in accordance with formula (I), a=y and b=z.

27. The mixture according to claim 1, wherein all contained luminescent compositions are respectively of the general formula (I):
G_{q}L_{1-q} (I),
wherein
q is a number between 0 and 1, preferably between 0.8 and 1, particularly preferably between 0.9 and 1, and
G is of the following formula (II):
Y₂₋ₓLaₓO_{3-y-z}SyF_{2z} (II)
wherein
x=between 0 and 2,
y=between 0 and 1, preferably y˜0 or ˜1,
z=between 0 and 0.25, preferably z=between 0.001 and 0.1, and
L is selected from two or more components of the following formula (III):
M′_{c}M″_{2-c}O_{3-a-b}SₐF_{2b} (III)
wherein
c=between 0 and 2,
a=between 0 and 1, preferably a˜0 or ˜1,
b=between 0 and 0.25, preferably b=between 001 and 0.1, and
M′ and M″ are respectively selected independently of each other from the group consisting of the trivalent cations of cerium, praseodymium, neodymium, samarium, europium, gadolinium, terbium, dysprosium, holmium, erbium, thulium, ytterbium and lutetium, wherein for each component in L the variables M′ and M″ stand for different trivalent cations,
wherein in the composition in accordance with formula (I), a=y and b=z.

28-29. (canceled)

30. An article, substance or mix of substances marked with a mixture as set forth in claim 1.

31. An article, substance or mix of substances marked with a luminescent composition as set forth in claim 23.
